(19) United States
(12) Patent Application Publication
(10) Pub. No.: US 2015/0146460 A1
(43) Pub. Date: May 28, 2015

(54) POWER FACTOR CORRECTION APPARATUS WITH VARIABLE CAPACITANCE

(71) Applicant: Chicony Power Technology Co., Ltd., New Taipei City (TW)

(72) Inventor: Ching-Chang LIN, New Taipei City (TW)

(73) Assignee: Chicony Power Technology Co., Ltd., New Taipei City (TW)

(21) Appl. No.: 14/092,506

(22) Filed: Nov. 27, 2013

(51) Int. Cl. H02M 1/42

(52) U.S. Cl. CPC H02M 1/4208
USPC 363/84; 323/209

(57) ABSTRACT

A power factor correction apparatus (10) is applied to a power application system (20). The power application system (20) outputs a rectified power (202) to the power factor correction apparatus (10). The power factor correction apparatus (10) includes a detection unit (102), a control unit (104), a variable capacitance unit (106) and a power factor correction unit (108). The variable capacitance unit (106) filters the rectified power (202). The detection unit (102) detects a status of the power application system (20) and then informs the control unit (104). According to the status of the power application system (20), the control unit (104) is configured to control a capacitance of the variable capacitance unit (106), so that a power factor of a power outputted from the power factor correction unit (108) to the power application system (20) is rising.

### BACKGROUND OF THE INVENTION

1. Field of the Invention

The present invention relates to a power factor correction apparatus, and especially relates to a power factor correction apparatus with variable capacitance.

2. Description of the Related Art

A power factor correction apparatus is a very common electronic circuit. Almost every power supply includes the power factor correction apparatus. The power supply further includes a bridge rectifier and a filter capacitor besides the power factor correction apparatus.

The bridge rectifier rectifies an alternating current power into a rectified power. Before the rectified power is transmitted to the power factor correction apparatus, the rectified power is filtered by the filter capacitor, so that the current ripples and the voltage ripples are reducing.

However, when the load is light or the input voltage is higher, the conduction time of the diodes of the bridge rectifier is shortening due to the filter capacitor, so that the input current is distorted and the current harmonic is increasing. Therefore, the power factor is decreasing.

### SUMMARY OF THE INVENTION

In order to solve the above-mentioned problems, an object of the present invention is to provide a power factor correction apparatus with variable capacitance.

In order to achieve the object of the present invention mentioned above, the power factor correction apparatus is applied to a power application system. The power application system outputs a rectified power to the power factor correction apparatus. The power factor correction apparatus includes a detection unit, a control unit, a variable capacitance unit and a power factor correction unit. The detection unit is electrically connected to the power application system. The control unit is electrically connected to the detection unit. The variable capacitance unit is electrically connected to the power application system and the control unit. The power factor correction unit is electrically connected to the power application system and the variable capacitance unit. The variable capacitance unit filters the rectified power. The detection unit detects a status of the power application system and then informs the control unit. According to the status of the power application system, the control unit is configured to control a capacitance of the variable capacitance unit, so that a power factor of a power outputted from the power factor correction unit to the power application system is rising.

The efficiency of the present invention is to control the capacitance of the filter capacitor to raise the power factor when the load is light or the input voltage is higher.

### BRIEF DESCRIPTION OF DRAWING

FIG. 1 shows a block diagram of the power factor correction apparatus of the present invention.

FIG. 2 shows a block diagram of the first embodiment of the power factor correction apparatus of the present invention.

FIG. 3 shows a circuit diagram of the first embodiment of the power factor correction apparatus of the present invention.

FIG. 4 shows a block diagram of the second embodiment of the power factor correction apparatus of the present invention.

FIG. 5 shows a circuit diagram of the second embodiment of the power factor correction apparatus of the present invention.

FIG. 6 shows a block diagram of the third embodiment of the power factor correction apparatus of the present invention.

FIG. 7 shows a circuit diagram of the third embodiment of the power factor correction apparatus of the present invention.

FIG. 8 shows a block diagram of the fourth embodiment of the power factor correction apparatus of the present invention.

FIG. 9 shows a block diagram of the fifth embodiment of the power factor correction apparatus of the present invention.

FIG. 10 shows a block diagram of the sixth embodiment of the power factor correction apparatus of the present invention.

### DETAILED DESCRIPTION OF THE INVENTION

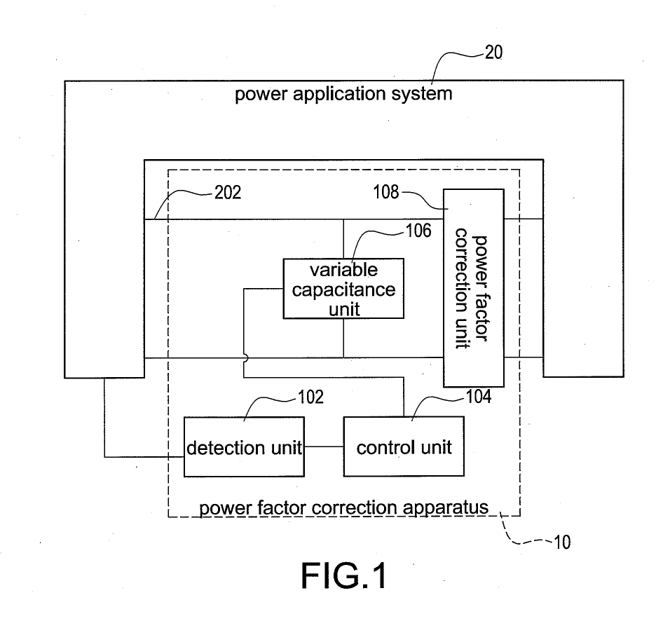

FIG. 1 shows a block diagram of the power factor correction apparatus of the present invention. A power factor correction apparatus 10 is applied to a power application system 20. The power application system 20 outputs a rectified power 202 to the power factor correction apparatus 10.

The power factor correction apparatus 10 includes a detection unit 102, a control unit 104, a variable capacitance unit 106 and a power factor correction unit 108.

The detection unit 102 is electrically connected to the power application system 20. The control unit 104 is electrically connected to the detection unit 102. The variable capacitance unit 106 is electrically connected to the power application system 20 and the control unit 104. The power factor correction unit 108 is electrically connected to the power application system 20 and the variable capacitance unit 106.

The variable capacitance unit 106 filters the rectified power 202. The detection unit 102 detects a status of the power application system 20 and then informs the control unit 104. According to the status of the power application system 20, the control unit 104 is configured to control a capacitance of the variable capacitance unit 106, so that a power factor of a power outputted from the power factor correction unit 108 to the power application system 20 is rising.

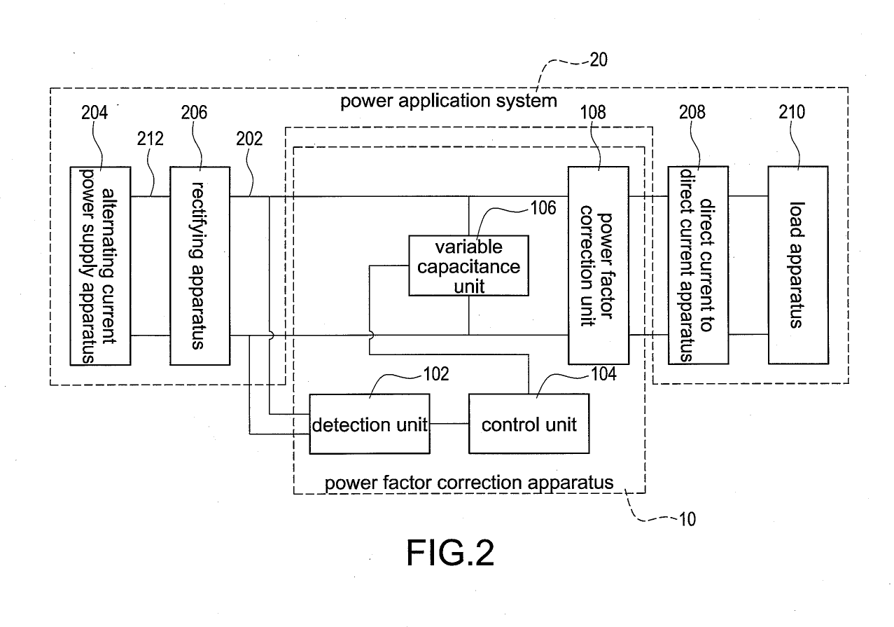

FIG. 2 shows a block diagram of the first embodiment of the power factor correction apparatus of the present invention. The description for the elements shown in FIG. 2, which are similar to those shown in FIG. 1, is not repeated here for brevity. Moreover, the power application system 20 includes an alternating current power supply apparatus 204, a rectifying apparatus 206, a direct current to direct current apparatus 208 and a load apparatus 210.

The rectifying apparatus 206 is electrically connected to the alternating current power supply apparatus 204, the detection unit 102, the variable capacitance unit 106 and the power factor correction unit 108. The direct current to direct current apparatus 208 is electrically connected to the power factor correction unit 108. The load apparatus 210 is electrically connected to the direct current to direct current apparatus 208.

The alternating current power supply apparatus 204 transmits an alternating current power 212 to the rectifying apparatus 206. The rectifying apparatus 206 rectifies the alternating current power 212 to derive the rectified power 202. The rectifying apparatus 206 transmits the rectified power 202 to the power factor correction apparatus 10.

The detection unit 102 detects a magnitude of the rectified power 202 and then informs the control unit 104 of the magnitude. The control unit 104 is configured to reduce the capacitance of the variable capacitance unit 106 if the rectified power 202 is increased. The control unit 104 is configured to increase the capacitance of the variable capacitance unit 106 if the rectified power 202 is decreased. Therefore, the power factor of the power outputted from the power factor correction unit 108 to the direct current to direct current apparatus 208 is rising.

For examples, the control unit 104 is configured to reduce the capacitance of the variable capacitance unit 106 by a first value if the rectified power 202 is larger than a rectified power threshold value. The control unit 104 is configured to increase the capacitance of the variable capacitance unit 106 by a second value if the rectified power 202 is not larger than the rectified power threshold value. The first value is not zero and the second value is not zero. Or, in, another embodiment, the capacitance of the variable capacitance unit 106 is inversely proportional to the rectified power 202.

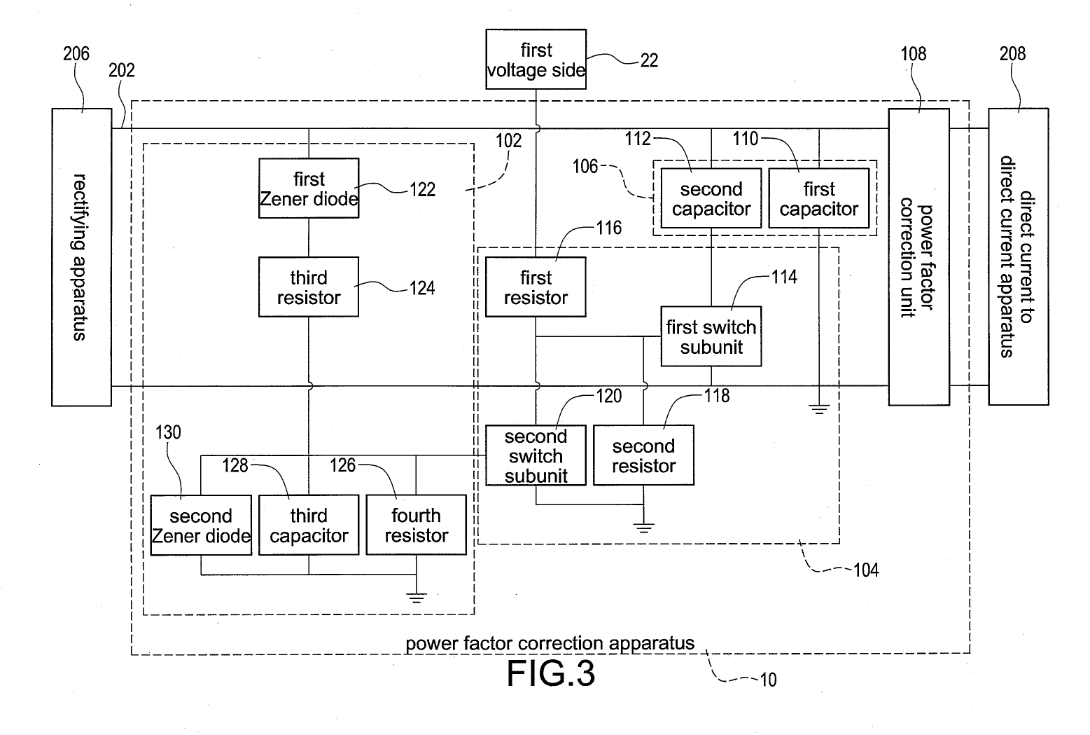

FIG. 3 shows a circuit diagram of the first embodiment of the power factor correction apparatus of the present invention. The description for the elements shown in FIG. 3, which are similar to those shown in FIG. 2, is not repeated here for brevity. Moreover, the power factor correction apparatus 10 is applied to a first voltage side 22.

The variable capacitance unit 106 includes a first capacitor 110 and a second capacitor 112. The first capacitor 110 is electrically connected to the power factor correction unit 108. The second capacitor 112 is electrically connected to the power factor correction unit 108.

The control unit 104 includes a first switch subunit 114, a first resistor 116, a second resistor 118 and a second switch subunit 120. The first switch subunit 114 is electrically connected to the second capacitor 112. The first resistor 116 is electrically connected to the first voltage side 22 and the first switch subunit 114. The second resistor 118 is electrically connected to the first switch subunit 114. The second switch subunit 120 is electrically connected to the first switch subunit 114.

The detection unit 102 includes a first Zener diode 122, a third resistor 124, a fourth resistor 126, a third capacitor 128 and a second Zener diode 130. The first Zener diode 122 is electrically connected to the rectifying apparatus 206. The third resistor 124 is electrically connected to the first Zener diode 122 and the second switch subunit 120. The fourth resistor 126 is electrically connected to the second switch subunit 120. The third capacitor 128 is electrically connected to the second switch subunit 120. The second Zener diode 130 is electrically connected to the second switch subunit 120.

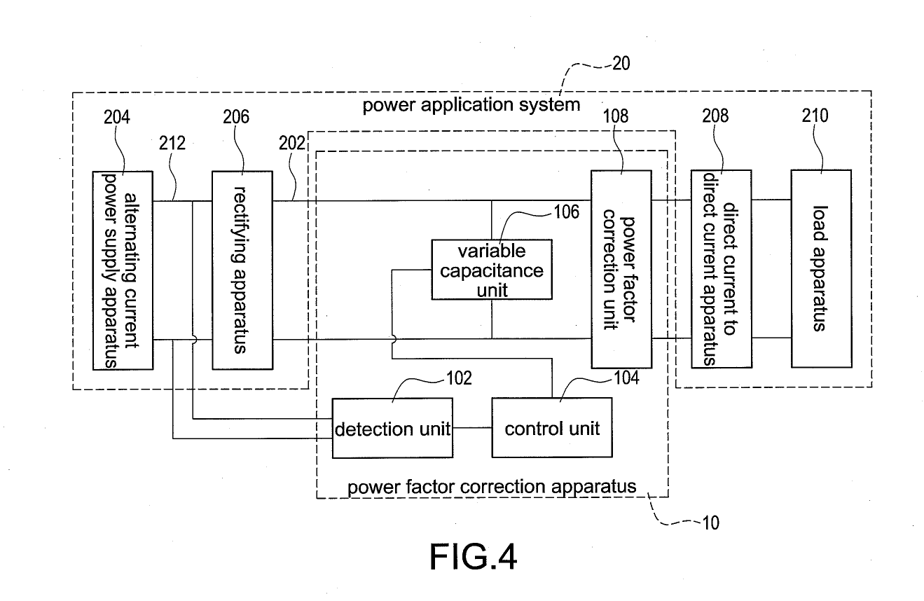

FIG. 4 shows a block diagram of the second embodiment of the power factor correction apparatus of the present invention. The description for the elements shown in FIG. 4, which are similar to those shown in FIG. 2, is not repeated here for brevity. Moreover, the alternating current power supply apparatus 204 is electrically connected to the detection unit 102.

The detection unit 102 detects a magnitude of the alternating current power 212 and then informs the control unit 104 of the magnitude. The control unit 104 is configured to reduce the capacitance of the variable capacitance unit 106 if an absolute value of the alternating current power 212 is increased. The control unit 104 is configured to increase the capacitance of the variable capacitance unit 106 if the absolute value of the alternating current power 212 is decreased. Therefore, the power factor of the power outputted from the power factor correction unit 108 to the direct current to direct current apparatus 208 is rising.

For examples, the control unit 104 is configured to reduce the capacitance of the variable capacitance unit 106 by a third value if the absolute value of the alternating current power 212 is larger than an alternating current power threshold value. The control unit 104 is configured to enlarge the capacitance of the variable capacitance unit 106 by a fourth value if the absolute value of the alternating current power 212 is not larger than the alternating current power threshold value. The third value is not zero and the fourth value is not zero. Or, in another embodiment, the capacitance of the variable capacitance unit 106 is inversely proportional to the absolute value of the alternating current power 212.

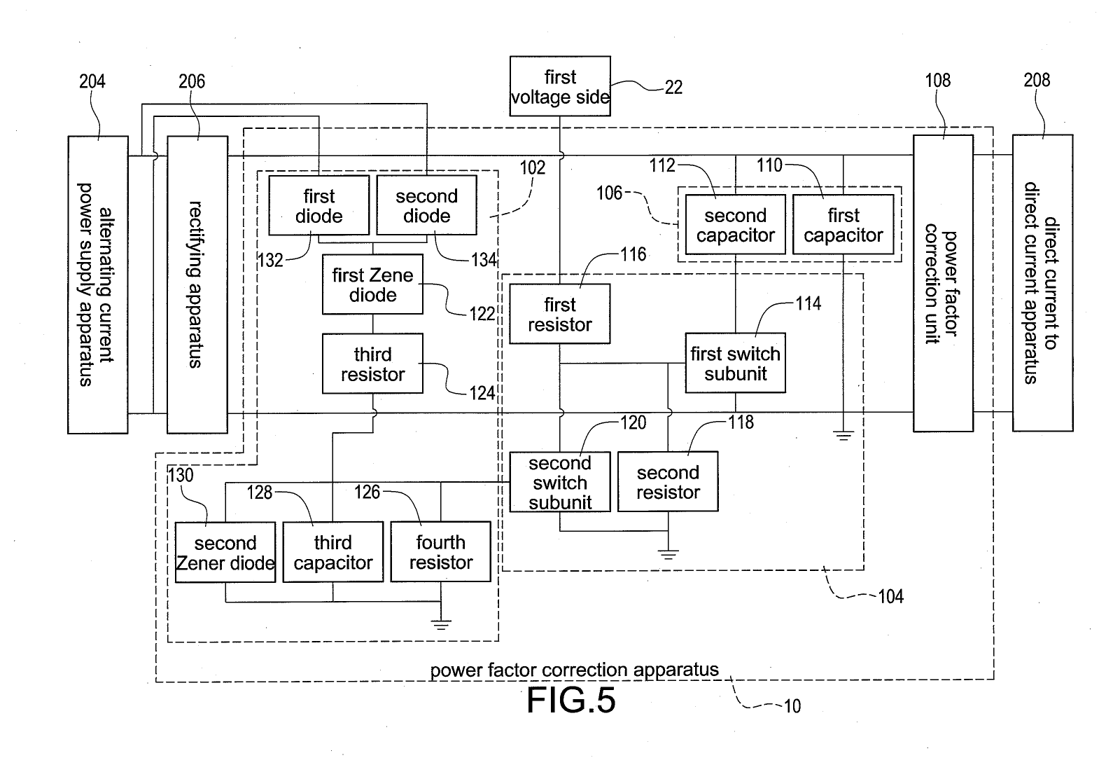

FIG. 5 shows a circuit diagram of the second embodiment of the power factor correction apparatus of the present invention. The description for the elements shown in FIG. 5, which are similar to those shown in FIG. 3 and FIG. 4, is not repeated here for brevity. Moreover, the detection unit 102 further includes a first diode 132 and a second diode 134. The first diode 132 is electrically connected to the alternating current power supply apparatus 204 and the rectifying apparatus 206. The second diode 134 is electrically connected to the alternating current power supply apparatus 204 and the rectifying apparatus 206. The first Zener diode 122 is electrically connected to the first diode 132 and the second diode 134.

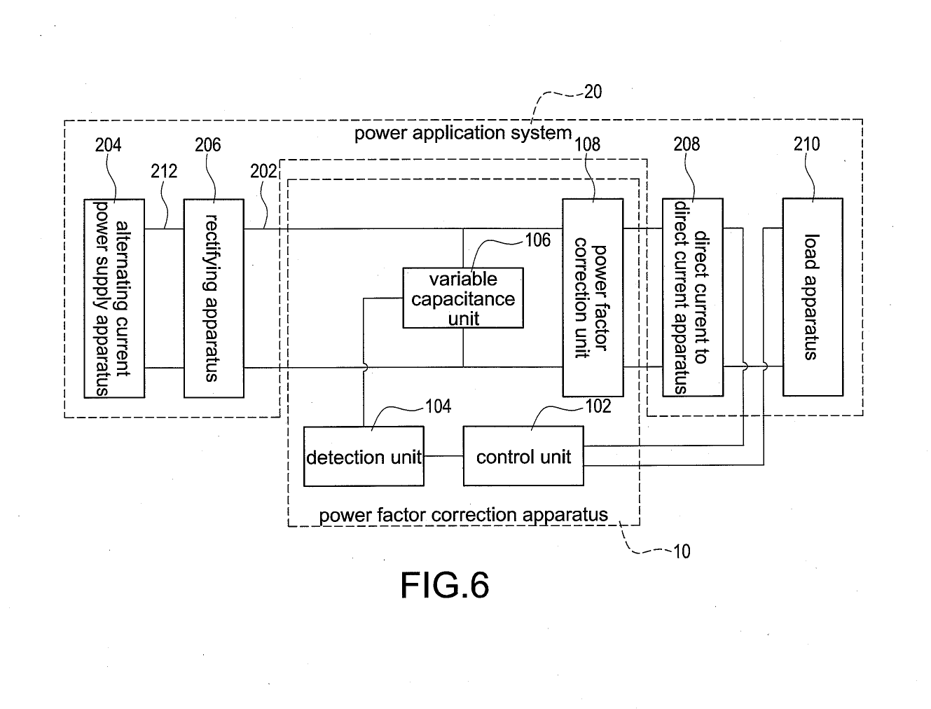

FIG. 6 shows a block diagram of the third embodiment of the power factor correction apparatus of the present invention. The description for the elements shown in FIG. 6, which are similar to those shown in FIG. 2, is not repeated here for brevity. Moreover, the direct current to direct current apparatus 208 is electrically connected to the power factor correction unit 108 and the detection unit 102. The load apparatus 210 is electrically connected to the detection unit 102.

The detection unit 102 detects a load (power consumption) of the load apparatus 210 and then informs the control unit 104. The control unit 104 is configured to reduce the capacitance of the variable capacitance unit 106 if the load of the load apparatus 210 is decreased (for example, the load apparatus 210 is standby and the power consumption is decreased). The control unit 104 is configured to increase the capacitance of the variable capacitance unit 106 if the load of the load apparatus 210 is increased (for example, the load apparatus 210 is in operation and the power consumption is increased). Therefore, the power factor of the power outputted from the power factor correction unit 108 to the direct current to direct current apparatus 208 is rising.

For examples, the control unit 104 is configured to reduce the capacitance of the variable capacitance unit 106 by a fifth value if the load of the load apparatus 210 is smaller than a load threshold value. The control unit 104 is configured to increase the capacitance of the variable capacitance unit 106 by a sixth value if the load of the load apparatus 210 is not smaller than the load threshold value. The fifth value is not zero and the sixth value is not zero. Or, in another embodiment, the capacitance of the variable capacitance unit 106 is proportional to the load of the load apparatus 210.

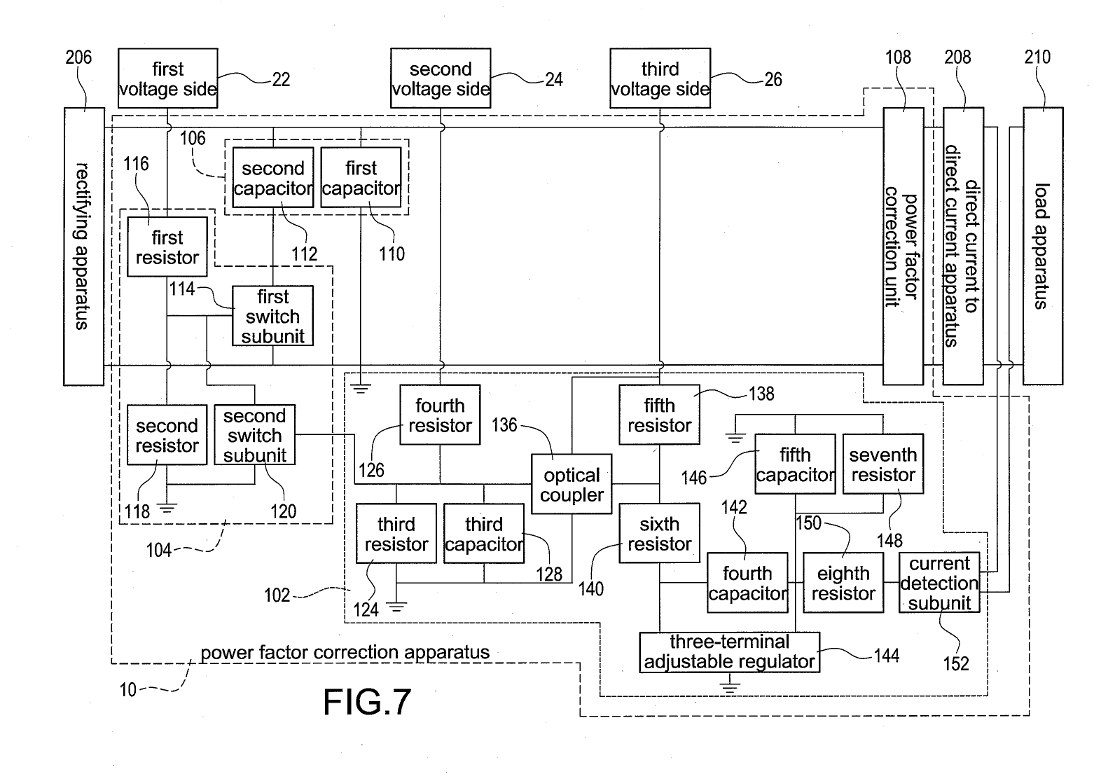

FIG. 7 shows a circuit diagram of the third embodiment of the power factor correction apparatus of the present invention. The description for the elements shown in FIG. 7, which are similar to those shown in FIG. 3 and FIG. 6, is not repeated here for brevity. Moreover, the power factor correction apparatus 10 is applied to a first voltage side 22, a second voltage side 24 and a third voltage side 26.

The detection unit 102 includes a third resistor 124, a third capacitor 128, a fourth resistor 126, an optical coupler 136, a fifth resistor 138, a sixth resistor 140, a fourth capacitor 142, a three-terminal adjustable regulator 144, a fifth capacitor 146, a seventh resistor 148, an eighth resistor 150 and a current detection subunit 152.

The third resistor 124 is electrically connected to the second switch subunit 120. The third capacitor 128 is electrically connected to the second switch subunit 120. The fourth resistor 126 is electrically connected to the second switch subunit 120 and the second voltage side 24. The optical coupler 136 is electrically connected to the second switch subunit 120 and the third voltage side 26. The fifth resistor 138 is electrically connected to the optical coupler 136 and the third voltage side 26. The sixth resistor 140 is electrically connected to the optical coupler 136. The fourth capacitor 142 is electrically connected to the sixth resistor 140. The three-terminal adjustable regulator 144 is electrically connected to the sixth resistor 140. The fifth capacitor 146 is electrically connected to the three-terminal adjustable regulator 144. The seventh resistor 148 is electrically connected to the three-terminal adjustable regulator 144. The eighth resistor 150 is electrically connected to the three-terminal adjustable regulator 144. The current detection subunit 152 is electrically connected to the eighth resistor 150, the direct current to direct current apparatus 208 and the load apparatus 210.

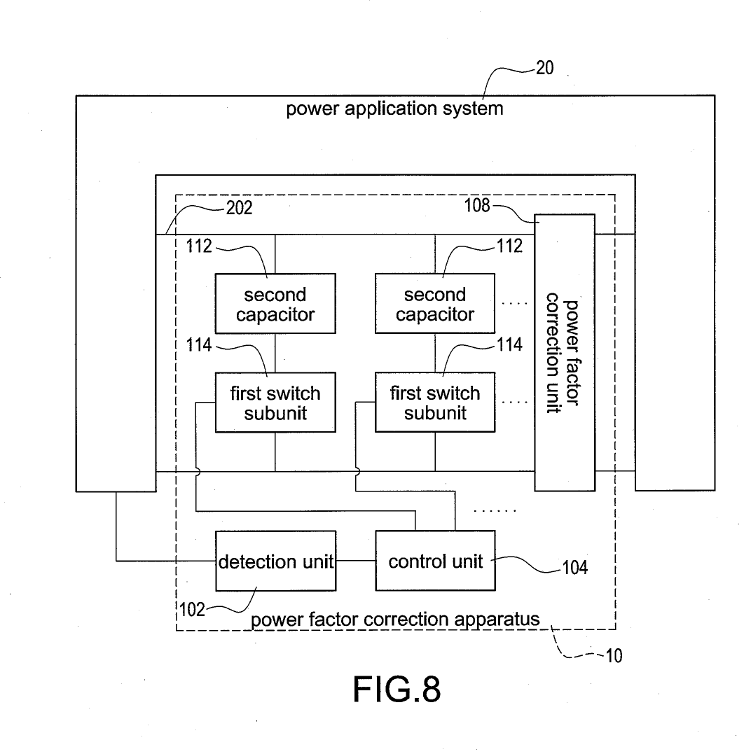

FIG. 8 shows a block diagram of the fourth embodiment of the power factor correction apparatus of the present invention. The description for the elements shown in FIG. 8, which are similar to those shown in FIG. 1-7, is not repeated here for brevity. Moreover, the power factor correction apparatus 10 includes a plurality of second capacitor 112 and a plurality of first switch subunit 114. The control unit 104 is a microcontroller or a microprocessor.

The control unit 104 is configured to turn on or turn off the first switch subunits 114 to reduce an overall capacitance of the second capacitors 112 (by a reduction of a seventh value) if the rectified power 202 is increased, or the absolute value of the alternating current power 212 is increased, or the load of the load apparatus 210 is decreased. The control unit 104 is configured to turn on or turn off the first switch subunits 114 to increase the overall capacitance of the second capacitors 112 (by an increase of an eighth value) if the rectified power 202 is decreased, or the absolute value of the alternating current power 212 is decreased, or the load of the load apparatus 210 is increased. The seventh value is not zero. The eighth value is not zero. Therefore, the power factor of the power outputted from the power factor correction unit 108 to the direct current to direct current apparatus 208 is rising. Moreover, the capacitance of each of the second capacitors 112 can be different.

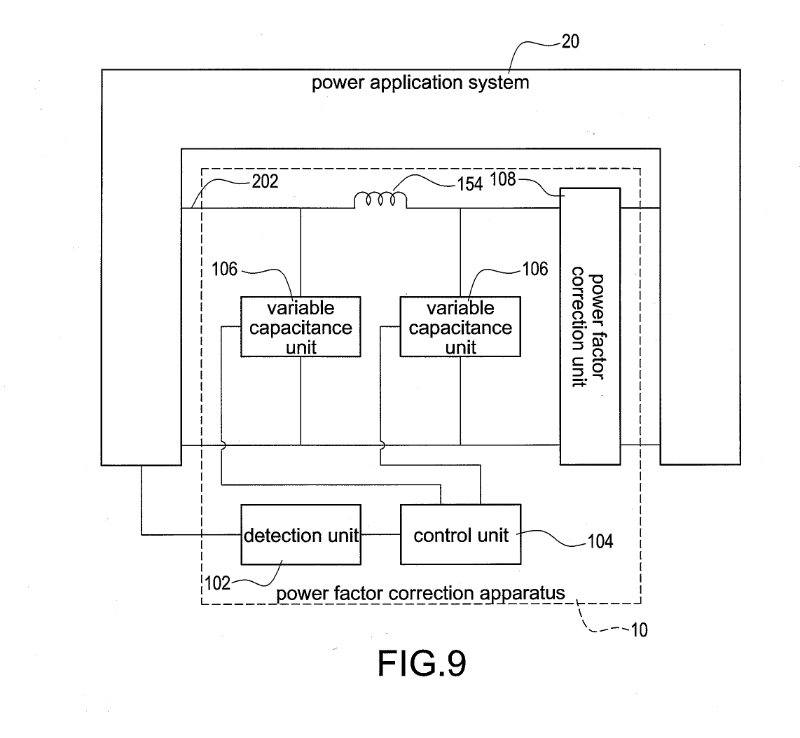

FIG. 9 shows a block diagram of the fifth embodiment of the power factor correction apparatus of the present invention. The description for the elements shown in FIG. 9, which are similar to those shown in FIG. 1-8, is not repeated here for brevity. Moreover, the power factor correction apparatus 10 includes two variable capacitance units 106 and an inductor 154. The inductor 154 is electrically connected to the variable capacitance units 106. A π-type filter is composed of the variable capacitance units 106 and the inductor 154

The control unit 104 is configured to reduce an overall capacitance of the variable capacitance units 106 (by a reduction of a ninth value) if the rectified power 202 is increased, or the absolute value of the alternating current power 212 is increased, or the load of the load apparatus 210 is decreased. The control unit 104 is configured to increase the overall capacitance of the variable capacitance units 106 (by an increase of a tenth value) if the rectified power 202 is decreased, or the absolute value of the alternating current power 212 is decreased, or the load of the load apparatus 210 is increased. The ninth value is not zero. The tenth value is not zero. Therefore, the power factor of the power outputted from the power factor correction unit 108 to the direct current to direct current apparatus 208 is rising.

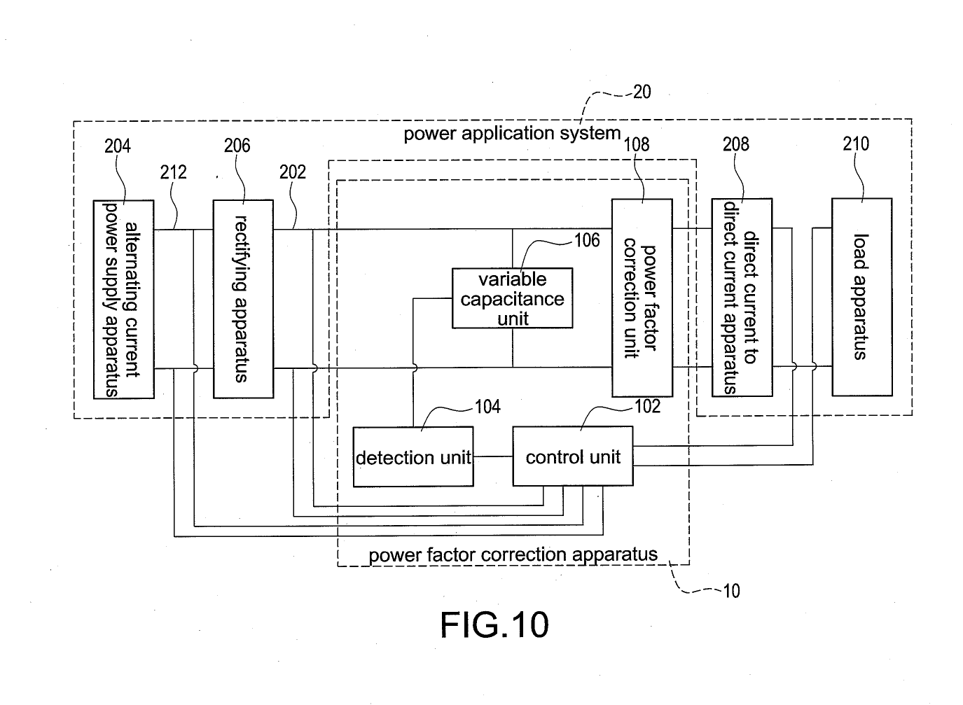

FIG. 10 shows a block diagram of the sixth embodiment of the power factor correction apparatus of the present invention. The description for the elements shown in FIG. 10, which are similar to those shown in FIG. 1-9, is not repeated here for brevity. Moreover, the detection unit 102 can detect the rectified power 202, and (or) detect the alternating current power 212, and (or) detect the load apparatus 210.

The efficiency of the present invention is to control the capacitance of the filter capacitor to raise the power factor when the load is light or the input voltage is higher.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power factor correction apparatus (10) applied to a power application system (20), the power application system (20) outputting a rectified power (202) to the power factor correction apparatus (10), the power factor correction apparatus (10) comprising:
a detection unit (102) electrically connected to the power application system (20);
a control unit (104) electrically connected to the detection unit (102);
a variable capacitance unit 106 electrically connected to the power application system (20) and the control unit (104); and
a power factor correction unit (108) electrically connected to the power application system (20) and the variable capacitance unit (106),
wherein the variable capacitance unit (106) filters the rectified power (202); the detection unit (102) detects a status of the power application system (20) and then informs the control unit (104); according to the status of the power application system (20), the control unit (104) is configured to control a capacitance of the variable capacitance unit (106), so that a power factor of a power outputted from the power factor correction unit (108) to the power application system (20) is rising.

2. The power factor correction apparatus (10) in claim 1, wherein the power application system (20) comprises:
an alternating current power supply apparatus (204);
a rectifying apparatus (206) electrically connected to the alternating current power supply apparatus (204), the detection unit (102), the variable capacitance unit (106) and the power factor correction unit (108);
a direct current to direct current apparatus (208) electrically connected to the power factor correction unit (108); and
a load apparatus (210) electrically connected to the direct current to direct current apparatus (208),
wherein the alternating current power supply apparatus (204) transmits an alternating current power (212) to the rectifying apparatus (206); the rectifying apparatus (206) rectifies the alternating current power (212) to derive the rectified power (202); the rectifying apparatus (206) transmits the rectified power (202) to the power factor correction apparatus (10);
wherein the detection unit (102) detects a magnitude of the rectified power (202) and then informs the control unit (104) of the magnitude; the control unit (104) is configured to reduce the capacitance of the variable capacitance unit (106) if the rectified power (202) is increased; the control unit (104) is configured to increase the capacitance of the variable capacitance unit (106) if the rectified power (202) is decreased; therefore, the power factor of the power outputted from the power factor correction unit (108) to the direct current to direct current apparatus (208) is rising.

3. The power factor correction apparatus (10) in claim 2, the power factor correction apparatus (10) applied to a first voltage side (22), wherein the variable capacitance unit (106) comprises:
a first capacitor (110) electrically connected to the power factor correction unit (108); and
a second capacitor (112) electrically connected to the power factor correction unit (108),
wherein the control unit (104) comprises:
a first switch subunit (114) electrically connected to the second capacitor (112);
a first resistor (116) electrically connected to the first voltage side (22) and the first switch subunit (114);
a second resistor (118) electrically connected to the first switch subunit (114); and
a second switch subunit (120) electrically connected to the first switch subunit (114).

4. The power factor correction apparatus (10) in claim 3, wherein the detection unit (102) comprises:
a first zener diode (122) electrically connected to the rectifying apparatus (206);
a third resistor (124) electrically connected to the first zener diode (122) and the second switch subunit (120);
a fourth resistor (126) electrically connected to the second switch subunit (120);
a third capacitor (128) electrically connected to the second switch subunit (120); and
a second zener diode (130) electrically connected to the second switch subunit (120).

5. The power factor correction apparatus (10) in claim 1, wherein the power application system (20) comprises:
an alternating current power supply apparatus (204) electrically connected to the detection unit 102;
a rectifying apparatus (206) electrically connected to the alternating current power supply apparatus (204), the detection unit (102), the variable capacitance unit (106) and the power factor correction unit (108);
a direct current to direct current apparatus (208) electrically connected to the power factor correction unit (108); and
a load apparatus (210) electrically connected to the direct current to direct current apparatus (208),
wherein the alternating current power supply apparatus (204) transmits an alternating current power (212) to the rectifying apparatus (206); the rectifying apparatus (206) rectifies the alternating current power (212) to derive the rectified power (202); the rectifying apparatus (206) transmits the rectified power (202) to the power factor correction apparatus (10);
wherein the detection unit (102) detects a magnitude of the alternating current power (212) and then informs the control unit (104) of the magnitude; the control unit (104) is configured to reduce the capacitance of the variable capacitance unit (106) if an absolute value of the alternating current power (212) is increased; the control unit (104) is configured to increase the capacitance of the variable capacitance unit (106) if the absolute value of the alternating current power (212) is decreased; therefore, the power factor of the power outputted from the power factor correction unit (108) to the direct current to direct current apparatus (208) is rising.

6. The power factor correction apparatus (10) in claim 5, the power factor correction apparatus (10) applied to a first voltage side (22), wherein the variable capacitance unit (106) comprises:
a first capacitor (110) electrically connected to the power factor correction unit (108); and
a second capacitor (112) electrically connected to the power factor correction unit (108),
wherein the control unit (104) comprises:
a first switch subunit (114) electrically connected to the second capacitor (112);
a first resistor (116) electrically connected to the first voltage side (22) and the first switch subunit (114);
a second resistor (118) electrically connected to the first switch subunit (114); and
a second switch subunit (120) electrically connected to the first switch subunit (114).

7. The power factor correction apparatus (10) in claim 6, wherein the detection unit (102) comprises:
a first diode 132 electrically connected to the alternating current power supply apparatus (204) and the rectifying apparatus (206);
a second diode (134) electrically connected to the alternating current power supply apparatus (204) and the rectifying apparatus (206);
a first zener diode (122) electrically connected to the first diode (132) and the second diode (134);
a third resistor (124) electrically connected to the first zener diode (122) and the second switch subunit (120);
a fourth resistor (126) electrically connected to the second switch subunit (120);
a third capacitor (128) electrically connected to the second switch subunit (120); and
a second zener diode (130) electrically connected to the second switch subunit (120).

8. The power factor correction apparatus (10) in claim 1, wherein the power application system (20) comprises:
an alternating current power supply apparatus (204);
a rectifying apparatus (206) electrically connected to the alternating current power supply apparatus (204), the variable capacitance unit (106) and the power factor correction unit (108);
a direct current to direct current apparatus (208) electrically connected to the power factor correction unit (108) and the detection unit (102); and
a load apparatus (210) electrically connected to the detection unit (102),
wherein the alternating current power supply apparatus (204) transmits an alternating current power (212) to the rectifying apparatus (206); the rectifying apparatus (206) rectifies the alternating current power (212) to derive the rectified power (202); the rectifying apparatus (206) transmits the rectified power (202) to the power factor correction apparatus (10);
wherein the detection unit (102) detects a load of the load apparatus (210) and then informs the control unit (104); the control unit (104) is configured to reduce the capacitance of the variable capacitance unit (106) if the load of the load apparatus (210) is decreased; the control unit (104) is configured to increase the capacitance of the variable capacitance unit (106) if the load of the load apparatus (210) is increased; therefore, the power factor of the power outputted from the power factor correction unit (108) to the direct current to direct current apparatus (208) is rising.

9. The power factor correction apparatus (10) in claim 8, the power factor correction apparatus (10) applied to a first voltage side (22), a second voltage side (24) and a third voltage side (26), wherein the variable capacitance unit (106) comprises:
a first capacitor (110) electrically connected to the power factor correction unit (108); and
a second capacitor (112) electrically connected to the power factor correction unit (108),
wherein the control unit (104) comprises:
a first switch subunit (114) electrically connected to the second capacitor (112);
a first resistor (116) electrically connected to the first voltage side (22) and the first switch subunit (114);
a second resistor (118) electrically connected to the first switch subunit (114); and
a second switch subunit (120) electrically connected to the first switch subunit (114).

10. The power factor correction apparatus (10) in claim 9, wherein the detection unit (102) comprises:
a third resistor (124) electrically connected to the second switch subunit (120);
a third capacitor (128) electrically connected to the second switch subunit (120);
a fourth resistor (126) electrically connected to the second switch subunit (120) and the second voltage side (24);
an optical coupler (136) electrically connected to the second switch subunit (120) and the third voltage side (26);
a fifth resistor (138) electrically connected to the optical coupler (136) and the third voltage side (26);
a sixth resistor (140) electrically connected to the optical coupler (136);
a fourth capacitor (142) electrically connected to the sixth resistor (140);
a three-terminal adjustable regulator (144) electrically connected to the sixth resistor (140);
a fifth capacitor (146) electrically connected to the three-terminal adjustable regulator (144);
a seventh resistor (148) electrically connected to the three-terminal adjustable regulator (144);
an eighth resistor (150) electrically connected to the three-terminal adjustable regulator (144); and
a current detection subunit (152) electrically connected to the eighth resistor (150), the direct current to direct current apparatus (208) and the load apparatus (210).
